(19) United States
(12) Patent Application Publication
(10) Pub. No.: US 2023/0205599 A1
(43) Pub. Date: Jun. 29, 2023

(54) METHOD, APPARATUS, AND COMPUTER READABLE MEDIUM

(71) Applicant: Rakuten Mobile, Inc., Tokyo (JP)

(72) Inventors: Mihir PATHAK, Tokyo (JP); Amey Sandesh WADEKAR, Tokyo (JP)

(21) Appl. No.: 17/645,945

(22) Filed: Dec. 23, 2021

(51) Int. Cl. G06F 9/50

(52) U.S. Cl. CPC G06F 9/5072; G06F 9/5044

(57) ABSTRACT

A method includes receiving cumulative resource requirements of an application, the application including a plurality of pods, and the cumulative resource requirements including subsets of resource requirements corresponding to each pod of the plurality of pods. Qualified server clusters of a plurality of server clusters are determined based on the cumulative resource requirements, each server cluster of the plurality of server clusters including a plurality of nodes. A working set of server clusters is selected by calculating scores of the qualified server clusters, a statistical metric of two or more of the subsets of resource requirements is calculated, the working set of server clusters are ranked by mapping the statistical metric to infrastructure resources of the plurality of nodes of each server cluster of the working set of server clusters, and a list of the ranked server clusters is output to a user.

### BACKGROUND

Telecom (e.g., wireless, cellular, etc.) and other application workloads are increasingly being transitioned to cloud native applications deployed on data centers that include multiple server clusters. The server clusters are capable of having a variety of resources that are often shared among multiple applications.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a communication system, in accordance with some embodiments.

FIG. 2 is a block diagram of a system, in accordance with some embodiments.

FIG. 3 is a flowchart of a method, in accordance with some embodiments.

FIG. 4 depicts a statistical metric calculation, in accordance with some embodiments.

FIG. 5 is a schematic view of a system, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, a method, apparatus, and computer readable medium are directed to automatically determining qualified server clusters of a plurality of server clusters based on resource requirements of an application, selecting a working set of server clusters by calculating scores of the qualified server clusters, calculating a statistical metric of two or more subsets of the resource requirements, ranking the working set of server clusters by mapping the statistical metric to infrastructure resources of each server cluster of the working set of server clusters, and outputting a list of the ranked server clusters to a user.

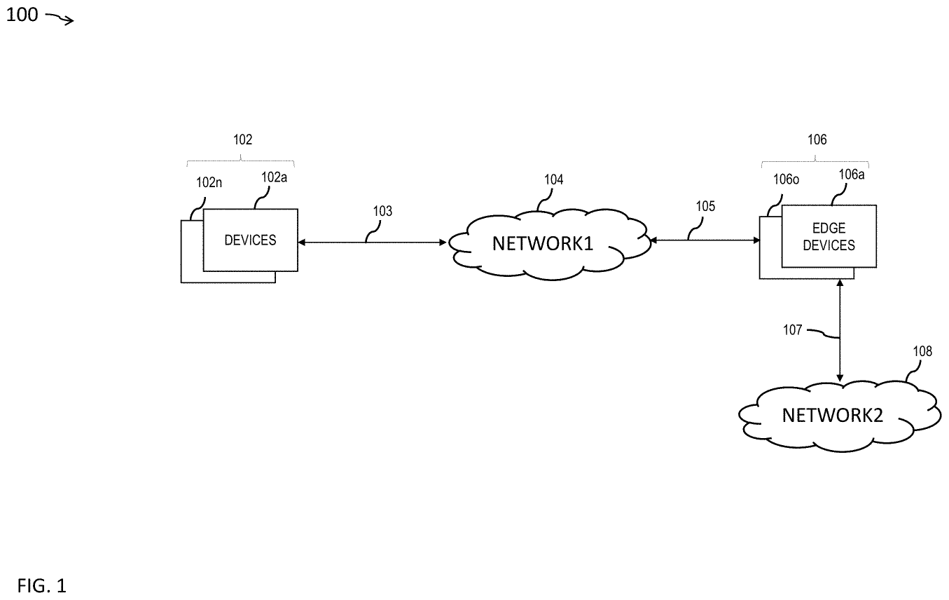

FIG. 1 is a block diagram of a communication system 100 (hereinafter referred to as “system 100”), in accordance with some embodiments.

System 100 includes a set of devices 102 coupled to a network 104 by a link 103, and network 104 is further coupled to a set of edge devices 106 by a link 105. System 100 further includes a network 108 coupled to the set of edge devices 106 by a link 107. The set of edge devices 106 and the set of devices 102 are coupled to each other by network 104.

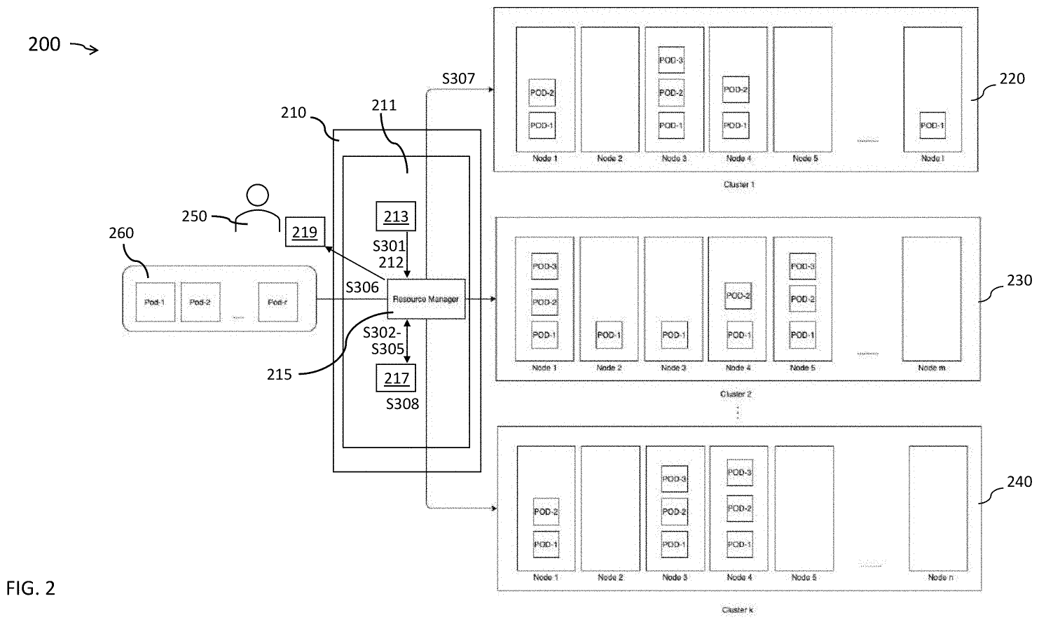

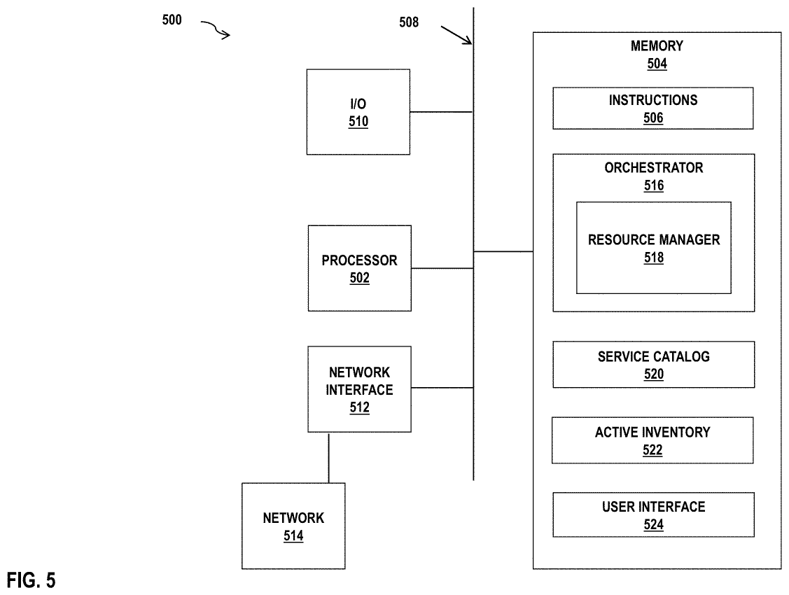

The set of devices 102 includes devices 102a, 102b, . . . 102n, where n is an integer corresponding to a number of devices in the set of devices 102. In some embodiments, one or more devices in the set of devices 102 corresponds to a computing device, a computing system or a server. In some embodiments, a device 210 (FIG. 2) corresponds to one or more of devices 102a, 102b, . . . 102n of the set of devices 102. In some embodiments, a system 500 (FIG. 5) is an embodiment of one or more of devices 102a, 102b, . . . 102n of the set of devices 102. In some embodiments, the set of devices 102 corresponds to a server farm. In some embodiments, the set of devices 102 corresponds to one or more data centers.

In some embodiments, one or more of devices 102a, 102b, . . . 102n of the set of devices 102 is a type of mobile terminal, fixed terminal, or portable terminal including a desktop computer, laptop computer, notebook computer, netbook computer, tablet computer, wearable circuitry, mobile handset, server, gaming console, or combination thereof. In some embodiments, one or more of devices 102a, 102b, . . . 102n of the set of devices 102 includes a display by which a user interface is displayed.

Other configurations, different types of devices or other number of sets in the set of devices 102 are within the scope of the present disclosure.

The set of edge devices 106 includes at least edge devices 106a, 106b, . . . 106o, where o is an integer corresponding to a number of edge devices in the set of edge devices 106. In some embodiments, integer o is greater than integer n. In some embodiments, integer o is greater than integer n by at least a factor of 100. In some embodiments, the integer o is greater than integer n by at least a factor of 1000. Other factors are within the scope of the present disclosure.

In some embodiments, one or more edge devices in the set of edge devices 106 corresponds to a computing device, computing system, or a server. In some embodiments, the set of edge devices 106 corresponds to one or more server clusters. In some embodiments, the set of edge devices 106 corresponds to server clusters 220, 230, and 240 (FIG. 2). In some embodiments, system 500 (FIG. 5) is an embodiment of one or more edge devices 106a, 106b, . . . 106o of the set of edge devices 106.

Other configurations, different types of edge devices or other number of sets in the set of edge devices 106 are within the scope of the present disclosure.

In some embodiments, at least one of network 104 or 108 corresponds to a wired or wireless network. In some embodiments, at least one of network 104 or 108 corresponds to a local area network (LAN). In some embodiments, at least one of network 104 or 108 corresponds to a wide area network (WAN). In some embodiments, at least one of network 104 or 108 corresponds to a metropolitan area network (MAN). In some embodiments, at least one of network 104 or 108 corresponds to an internet area network (IAN), a campus area network (CAN) or a virtual private networks (VPN). In some embodiments, at least one of network 104 or 108 corresponds to the Internet.

Other configurations, number of networks or different types of network in at least network 104 or 108 are within the scope of the present disclosure.

In some embodiments, at least one of link 103, 105, or 107 is a wired link. In some embodiments, at least one of link 103, 105, or 107 is a wireless link. In some embodiments, at least one of link 103, 105, or 107 corresponds to any transmission medium type; e.g. fiber optic cabling, any wired cabling, and any wireless link type(s). In some embodiments, at least one of link 103, 105, or 107 corresponds to shielded, twisted-pair cabling, copper cabling, fiber optic cabling, and/or encrypted data links.

In some embodiments, at least one of link 103, 105, or 107 is based on different technologies, such as code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that may be used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least one of link 103, 105, or 107 are within the scope of the present disclosure. For example, while FIG. 1 shows a single link for each of links 103, 105, and 107, one or more of links 103, 105, or 107 include a plurality of links.

Other configurations or number of elements in system 100 are within the scope of the present disclosure.

FIG. 2 is a block diagram of a system 200, in accordance with some embodiments. FIG. 2 is simplified for the purpose of illustration.

System 200 is an embodiment of system 100, and similar detailed description is omitted.

System 200 includes a device 210 connected to a number k of server clusters; the first cluster, Cluster 1, is designated as server cluster 220, the second cluster, Cluster 2, is designated as server cluster 230, and the kth cluster, Cluster 3, is designated as server cluster 240.

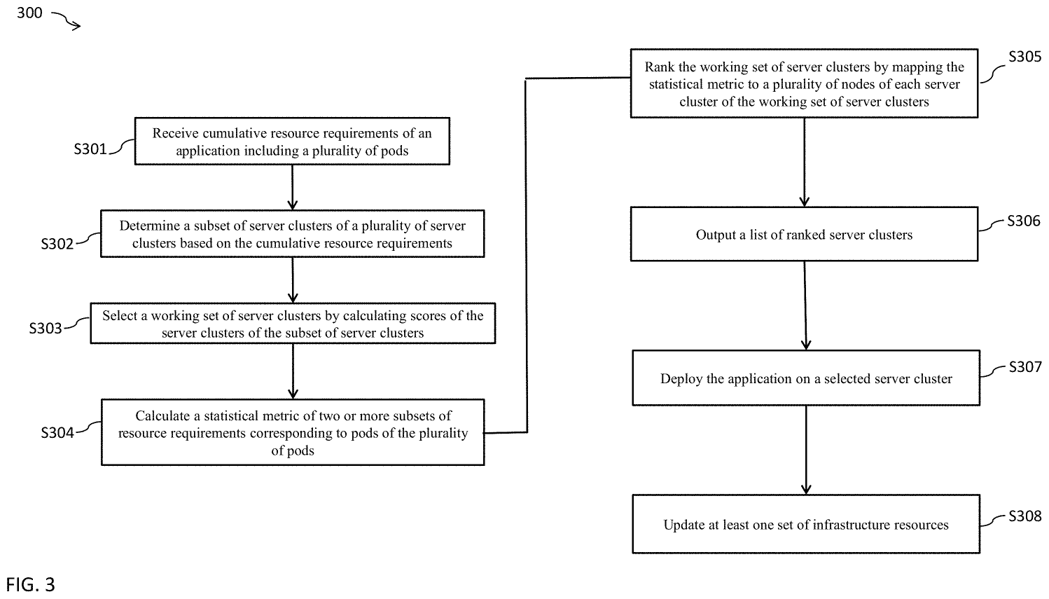

System 200 shows a series of steps or operations (e.g., S301, S302-S305, S306, and S307), performed by system 200, and are described in FIG. 3 as a method 300.

Device 210 is an embodiment of one or more devices in the set of devices 102 of FIG. 1, and similar detailed description is omitted. Each of server clusters 220, 230, . . . 240 is an embodiment of one or more edge devices in the set of edge devices 106 of FIG. 1, and similar detailed description is omitted. Device 210 is coupled to each of server clusters 220, 230, . . . 240 by a network (not shown), such as network 104.

Each of server clusters 220, 230, . . . 240 is a logical entity of a group of servers, e.g., a group of servers collectively controlled to provide backup or other capabilities. Subsets of server clusters 220, 230, . . . 240 are located in data centers (not shown), each data center including at least one server cluster of server clusters 220, 230, . . . 240. In some embodiments, system 200 includes tens of data centers. In some embodiments, system 200 includes hundreds or thousands of data centers.

In some embodiments, a given data center includes tens of server clusters of server clusters 220, 230, . . . 240. In some embodiments, a given data center includes hundreds or thousands of server clusters of server clusters 220, 230, . . . 240.

In some embodiments, system 200 includes the total number k of server clusters 220, 230, . . . 240 ranging from tens of server clusters to hundreds of thousands of server clusters. In some embodiments, system 200 includes the total number k of server clusters 220, 230, . . . 240 ranging from hundreds of server clusters to thousands of server clusters. In some embodiments, data centers and the corresponding server clusters 220, 230, . . . 240 are referred to as an ecosystem.

Device 210 is configured to receive one or more software applications, e.g., an application 260, from one or more users (represented collectively as user 250), and automatically deploy the one or more software applications on corresponding one or more server clusters of server clusters 220, 230, . . . 240. Server clusters 220, 230, . . . 240 are configured to store, execute and provide access to the one or more deployed applications by network 104 and 108 to other devices (including the set of devices 102).

Device 210 includes an orchestrator 211. Orchestrator 211 is one or more sets of instructions, e.g., program code, configured to automatically provision, orchestrate, manage, and deploy the one or more software applications on server clusters 220, 230, . . . 240. Orchestrator 211 is configured to automatically retrieve cumulative resource requirements 212 of an application from a service catalog 213, and use a resource manager 215 to execute an algorithm to match the cumulative resource requirements 212 to infrastructure resources tracked in a server cluster database 217, and generate a list 219 of ranked subset server clusters 220, 230, . . . 240, as discussed below.

In some embodiments, orchestrator 211 of device 210 is the sole orchestrator of a particular ecosystem, e.g., server clusters 220, 230, . . . 240. In some embodiments, orchestrator 211 of device 210 is one of multiple orchestrators 211 of corresponding multiple devices 210 of a particular ecosystem.

Orchestrator 211 includes a user interface, e.g., a user interface 524 discussed below with respect to FIG. 5, capable of displaying information, e.g., list 219, to user 250, and receiving user instructions from user 250. In some embodiments, user 250 represents a single user. In some embodiments, user 250 represents multiple users.

Orchestrator 211 is configured to store and update information related to user 250 and software applications, e.g., application 260, in service catalog 213. Service catalog 213 is one or more storage devices configured to store data corresponding to clients of device 210, e.g., user 250, and resource requirements, e.g., cumulative resource requirements 212, and other data suitable for deploying and maintaining various software applications on the ecosystem including device 210.

In some embodiments, service catalog 213 includes a database. In the embodiment depicted in FIG. 2, service catalog 213 is located in device 210. In some embodiments, service catalog 213 is located partially or entirely external to device 210, e.g., on another device 102 or on an edge device 106.

In addition to storing resource requirements, e.g., cumulative resource requirements 212, in service catalog 213, orchestrator 211 is configured to automatically retrieve some or all of the resource requirements from service catalog 213 responsive to instructions received from user 250, the instructions including an identifier of the software application.

Orchestrator 211 is configured to retrieve resource requirements from service catalog 213 as cumulative resource requirements 212 of application 260. In some embodiments, cumulative resource requirements 212 are a subset of the resource requirements of application 260 stored in service catalog 213. In some embodiments, cumulative resource requirements 212 are an entirety of the resource requirements of application 260 stored in service catalog 213.

Software applications include multiple pods, each pod corresponding to a subset of the cumulative resource requirements of the software application including the pod. In the embodiment depicted in FIG. 2, application 260 includes a number r of pods Pod-1, Pod-2, . . . Pod-r. In some embodiments, application 260 includes the number r of pods Pod-1, Pod-2, . . . Pod-r ranging from four to one hundred. In some embodiments, application 260 includes the number r of pods Pod-1, Pod-2, . . . Pod-r ranging from eight to fifty.

For a given software application, the resource requirements stored in service catalog 213 include subsets of the cumulative resource requirements, e.g., cumulative resource requirements 212, corresponding to the pods of the given software application.

Each server cluster of server clusters 220, 230, . . . 240 includes multiple nodes corresponding to subsets of the infrastructure resources of the server cluster. In some embodiments, the nodes correspond to servers of a given server cluster. In some embodiments, a node corresponds to more than one server, a portion of a server, or multiple portions or entireties of multiple servers of a given server cluster.

In the embodiment depicted in FIG. 2, Cluster 1 includes a total number of l nodes, Cluster 2 includes a total number of m nodes, and Cluster 3 includes a total number of n nodes. In some embodiments, each of numbers l, m, and n is the same. In some embodiments, one or more of numbers l, m, and n is different from one or more others of numbers l, m, and n.

In some embodiments, one or more of server clusters 220, 230, . . . 240 includes numbers 1, m, or n of nodes ranging from four to one hundred. In some embodiments, one or more of server clusters 220, 230, . . . 240 includes numbers 1, m, or n of nodes ranging from eight to fifty.

In the embodiment depicted in FIG. 2, each node is capable of hosting a total of three pods. In some embodiments, one or more nodes is capable of hosting greater or fewer than three pods. In some embodiments, each node is capable of hosting a same number of pods. In some embodiments, various nodes are capable of hosting varying numbers of pods.

Device 210 includes a resource manager 215. Resource manager 215 is one or more sets of instructions, e.g., program code, configured to automatically maintain a server cluster database 217, also referred to as active inventory 217 in some embodiments, in which infrastructure information corresponding to server clusters 220, 230, . . . 240 is stored. For a given server cluster of server clusters 220, 230, . . . 240, the infrastructure information includes subsets corresponding to the resource capabilities of the nodes of the given server cluster.

In the embodiment depicted in FIG. 2, resource manager 215 is a component of orchestrator 211. In some embodiments, resource manager 215 is separate from orchestrator 211.

Server cluster database 217 is one or more storage devices configured to store data corresponding to the resource capabilities of the server clusters and nodes of server clusters 220, 230, . . . 240. The resource capabilities include at least capabilities corresponding to cumulative resource requirements 212. The stored data represent hardware and software capacities of each server cluster of server clusters 220, 230, . . . 240, and available subsets of the various capacities based on server clusters being used by deployed applications and/or reserved for potential future application deployments. Resource manager 215 is configured to automatically update server cluster database 217 based on software deployments and/or reservations.

In the embodiment depicted in FIG. 2, server cluster database 217 is a database. In some embodiments, server cluster database 217 is another type of data storage, e.g., one or more data files, configured to store the resource capabilities data.

In the embodiment depicted in FIG. 2, server cluster database 217 is located in device 210. In some embodiments, server cluster database 217 is located partially or entirely external to device 210, e.g., on another device 102 or on an edge device 106.

Resource requirements, e.g., cumulative and pod-level subsets of resource requirements 212, and resource capabilities of server clusters and nodes of server clusters 220, 230, . . . 240, include one or more of a memory requirement/capability, a storage requirement/capability, a central processing unit (CPU) requirement/capability, a supplemental processing requirement/capability, an input-output (I/O) or other hardware interface requirement/capability, a software requirement/capability, a user-specified requirement/capability, or other technical requirement and/or capability suitable for storing and/or executing software applications.

In some embodiments, a memory requirement/capability includes one or more of a memory size, type, configuration, or other criteria suitable for defining computer memory capabilities, e.g., gigabytes (GB) of random-access memory (RAM). A storage requirement/capability includes one or more of a storage type, e.g., hard disk drive (HDD) or solid state drive (SSD), size, configuration, or other criteria suitable for defining data storage capabilities.

In some embodiments, a CPU requirement/capability includes one or more of a number of physical or virtual processor cores, processor speed, or other criteria suitable for defining general computer processing capabilities. A supplemental processing requirement/capability includes one or more application-specific computational requirements/capabilities, e.g., a graphics processing unit (GPU) requirement/capability, a field-programmable gate array (FPGA) requirement/capability, or other requirement/capability provided by hardware supplemental to general processing hardware.

In some embodiments, an I/O or other hardware interface requirement/capability includes one or more of a network interface card (NIC), a single root I/O virtualization (SRIOV), open virtual switch (OVS), or other criteria suitable for defining interfacing capabilities.

In some embodiments, a software requirement/capability includes one or more of an operating system (OS) requirement/capability, e.g., an OS type and/or version, an application programming interface (API) requirement/capability, or other supplemental software requirement/capability.

In some embodiments, a user-specified requirement/capability includes one or more of a geographic location or region, e.g., a country, including one or more of server clusters 220, 230, . . . 240, a data center type such as a group center (GC) type corresponding to far edge data centers, a regional data center (RDC) type corresponding to near edge data centers, or a central data center (CDC) type corresponding to centrally located data centers, or other criteria provided by a user suitable for specifying a data center or server cluster technical requirement/capability.

In some embodiments, an other technical requirement/capability includes one or more of a resource pool (Rpool) requirement/capability, a tag identifying an application type of the software application, or other application-specific criteria suitable for identifying server cluster compatibility.

In some embodiments, resource requirements, e.g., cumulative and pod-level subsets of resource requirements 212, correspond to application 260 being an information technology (IT) application configured to execute on server clusters 220, 230, . . . 240 corresponding to one or more public, general-application cloud environments. In some embodiments, cumulative and pod-level subsets of resource requirements 212 include one or more GPU requirements corresponding to an IT application.

In some embodiments, resource requirements, e.g., cumulative and pod-level subsets of resource requirements 212, correspond to application 260 being a telecommunication (Telco) application configured to execute on server clusters 220, 230, . . . 240 corresponding to one or more private, application-specific environments, e.g., a virtual radio access network (vRAN). In some embodiments, cumulative and pod-level subsets of resource requirements 212 include one or more FPGA and/or hardware interface requirements corresponding to a Telco application.

Resource manager 215 is configured to analyze server cluster database 217 based on cumulative and pod-level subsets of resource requirements 212 by executing some or all of method 300, and thereby generate list 219 of recommended server clusters.

In some embodiments, resource manager 215 generates list 219 including the number of server clusters equal to three. In some embodiments, resource manager 215 generates list 219 including the number of server clusters greater or fewer than three. In some embodiments, resource manager 215 generates list 219 including the number of server clusters included in user information received from user 250.

Resource manager 215 is configured to output list 219 to user 250 and to receive an indication from user 250 of a selection of a server cluster from list 219. In response to receiving the selection, resource manager 215 and/or orchestrator 211 is configured to deploy the software application on the selected server cluster.

In some embodiments, after deployment of the software application, resource manager 215 is configured to update server cluster database 217 to reflect the change in hardware and software capacities of the server clusters 220, 230, . . . 240 corresponding to the software application deployment.

FIG. 3 is a flowchart of method 300, in accordance with some embodiments.

In some embodiments, method 300 is a method of determining qualified server clusters of a plurality of server clusters based on resource requirements of an application, selecting a working set of server clusters by calculating scores of the qualified server clusters, calculating a statistical metric of two or more subsets of the resource requirements, ranking the working set of server clusters by mapping the statistical metric to infrastructure resources of each server cluster of the working set of server clusters, and outputting a list of the ranked server clusters to a user. In some embodiments, at least portions of method 300 are performed by resource manager 215 and/or orchestrator 211.

In some embodiments, FIG. 3 is a flowchart of a method of operating system 100 of FIG. 1 or system 200 of FIG. 2, and similar detailed description is therefore omitted. It is understood that additional operations may be performed before, during, between, and/or after the operations of method 300 depicted in FIG. 3, and that some other operations may only be briefly described herein. In some embodiments, other orders of operations of method 300 are within the scope of the present disclosure. In some embodiments, one or more operations of method 300 are not performed.

Method 300 includes exemplary operations, but the operations are not necessarily performed in the order shown. Operations may be added, replaced, changed order, and/or eliminated as appropriate, in accordance with the spirit and scope of disclosed embodiments.

In operation S301 of method 300, cumulative resource requirements 212 of application 260 including plurality of pods Pod-1, Pod-2, . . . Pod-r are received. In some embodiments, cumulative resource requirements 212 are received from service catalog 213 by resource manager 215.

In some embodiments, receiving cumulative resource requirements 212 of application 260 includes receiving cumulative resource requirements 212 in response to receiving a user instruction from user 250 by orchestrator 211, the user instruction including an identifier of application 260.

In operation S302 of method 300, a subset of server clusters of plurality of server clusters 220, 230, . . . 240 is determined based on cumulative resource requirements 212. Each server cluster of plurality of server clusters 220, 230, . . . 240 includes nodes, each node includes a set of infrastructure resources represented in server cluster database 217, and determining the qualified server clusters includes comparing an aggregate of the sets of infrastructure resources of each server cluster to cumulative resource requirements 212. Determining that a server cluster is a qualified server cluster includes concluding that the corresponding aggregate of the sets of infrastructure resources is greater than or equal to cumulative resource requirements 212.

In some embodiments, determining the subset of server clusters includes, prior to determining the qualified server clusters, filtering server clusters 220, 230, . . . 240 by matching one or more application-related elements, e.g., tags, location indicators, data center types, or the like, with one or more corresponding server cluster features represented in server cluster database 217. In some embodiments, matching the one or more elements includes receiving at least one element from user 250. In some embodiments, matching the one or more elements includes receiving at least one element from service catalog 213.

In operation S303 of method 300, a working set of server clusters is selected by calculating scores of the server clusters of the subset of server clusters 220, 230, . . . 240. In some embodiments, selecting the working set of server clusters is referred to as a worst-fit operation.

Calculating the score includes summing differences between server cluster capacity and cumulative resource requirements 212 for each requirement of a plurality of requirements of cumulative resource requirements 212. In some embodiments, summing the differences includes calculating a score as

Score=Σ_{d∈D}(Cd−Rd)/Cd (1)

where C=allocatable cumulative (aggregate) capacity of the cluster, R=requested cumulative resources for the application, and D={vCPU, GPU, RAM, STORAGE_SSD, STORAGE_HDD}. In this non-limiting example, vCPU corresponds to a processor requirement/capability, GPU corresponds to a graphical processor requirement/capability, RAM corresponds to a memory requirement/capability, STORAGE_SSD corresponds to an SSD storage requirement/capability, and STORAGE_HDD corresponds to an HDD storage requirement/capability.

The scores for each sever cluster of the subset of server clusters are sorted in descending order and normalized to a score of 100 in some embodiments. Selecting the working set of a number W of server clusters of the subset of server clusters is performed by selecting W server clusters having the highest scores.

In some embodiments, the number W is predetermined, e.g., stored by resource manager 215. In some embodiments, the number W is determined during execution of operation S303, e.g., based on available resources. In some embodiments, the number W is received from user 250 by resource manager 215. As the number W increases, both execution time and accuracy of various operations of method 300, e.g. operations S304 and S305, increase.

In operation S304 of method 300, a statistical metric of two or more subsets of resource requirements corresponding to pods of the plurality of pods Pod-1, Pod-2, . . . Pod-r is calculated. In some embodiments, calculating the statistical metric of two or more subsets of resource requirements corresponding to pods is referred to as a window operation.

Calculating the statistical metric includes dividing the plurality of pods Pod-1, Pod-2, . . . Pod-r into the two or more subsets (also referred to as groups or windows), each group including a number K of pods. In some embodiments, the number K is predetermined, e.g., stored by resource manager 215. In some embodiments, the number K is determined during execution of operation S304, e.g., based on available resources. In some embodiments, the number K is received from user 250 by resource manager 215. As the number K increases, execution time of various operations of method 300, e.g., operation S304, decreases and accuracy decreases.

For each group of pods of application 260, calculating the statistical metric includes calculating a normalized score based on the cumulative requirements of the pods of each group for each of two or more resource requirements of the cumulative resource requirements, e.g., cumulative resource requirements 212. Normalization of the scores is based on maximum resource requirements.

In a non-limiting example of a group including pods A, B, and C, pod A has a requirement of 4 vCPU cores and 10 GB RAM, pod B has a requirement of 6 vCPU cores and 5 GB RAM, and pod C has a requirement of 3 vCPU cores and 8 GB RAM. In this example, normalization is thereby based on a maximum vCPU requirement=6 and a maximum RAM requirement=10, with the scores given by

Normalized score of Pod A=4/6+10/10=1.6667 (2)

Normalized score of Pod B=6/6+5/10=1.5 (3)

Normalized score of Pod C=3/6+8/10=1.3 (4)

In some embodiments, the pods are sorted in ascending score order, e.g., for the purpose of computational efficiency. In this example, the pods would be sorted in the order of Pod C, Pod B, and Pod A.

Calculating the statistical metric includes, for each group of pods, calculating one of a minimum, a maximum, a mean, or an average of each requirement of the plurality of requirements of cumulative resource requirements 212. The multi-dimensional metric is then used for comparisons to the available resources on the nodes of the working set of server clusters as discussed below with respect to operation S305.

In some embodiments, the choice of minimum, maximum, mean, or average is a predetermined choice. In some embodiments, the choice of minimum, maximum, mean, or average is determined during execution of operation S304, e.g., based on available resources. In some embodiments, the choice of minimum, maximum, mean, or average is received from user 250 by resource manager 215. In some embodiments, the choice of minimum or average corresponds to a best effort check. In some embodiments, the choice of maximum or mean corresponds to a higher quality computation requiring more time than the choice of minimum or average.

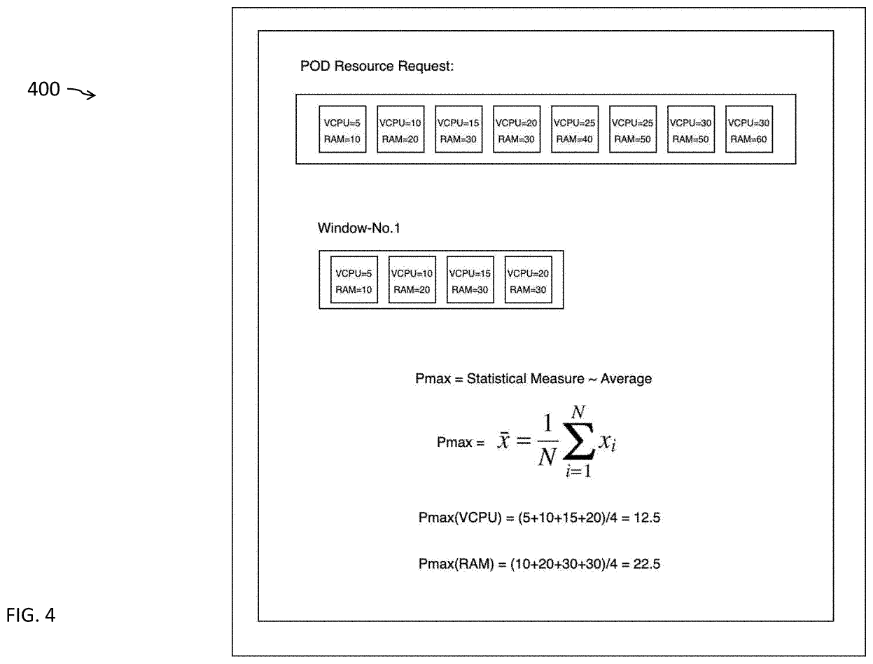

FIG. 4 depicts a statistical metric calculation 400, in accordance with some embodiments. In the non-limiting example depicted in FIG. 4, a group Window-No. 1 includes the number K of pods equal to four, and application 260 includes a total of eight pods. Statistical metric calculation 400A includes calculating two-dimensional statistical metric Pmax based on processor and memory requirements for each pod in Window-No. 1.

In operation S305 of method 300, the working set of server clusters is ranked by mapping the statistical metric to the plurality of nodes of each server cluster of the working set of server clusters 220, 230, . . . 240.

Mapping the statistical metric to the plurality of nodes of each server cluster of the working set of server clusters includes evaluating the server clusters of the working set of server clusters in the ascending score order discussed above. For each server cluster, the evaluation includes sequentially performing an evaluation for each group of pods based on the statistical metric discussed above. At a first node, the statistical metric of a first group of pods is compared to the available resources and, if the available resources are greater or equal to those of the statistical metric, the first group of pods is determined to be capable of being assigned to the first node. If not, the evaluation continues to each additional node until available resources are identified or the server cluster is determined to be unusable for receiving application 260.

In some embodiments, the nodes of a given server cluster are first filtered by comparing the resource availability to the statistical metric to each node and passing only those nodes that have available resources greater than or equal to the statistical metric.

In some embodiments, the filtered (in some embodiments) nodes are sorted according to a worst fit or best fit hierarchy. In some embodiments, the groups of pods are assigned to nodes using a first fit operation in which a first match between a given group of pods and a given node is sufficient for the group of pods to be assigned to the node.

After a group of pods is assigned to a node, the node is flagged as unavailable, and the evaluation continues until all groups of pods have been assigned to a node in the corresponding server cluster or the server cluster is determined to be unusable. A non-limiting example of a node-level mapping operation is provided below: Initialize a evaluated_node_set=null,

For each window:

```
Filter Nodes using M < Cnode where Cnode =
{Cnode_{CPU}, Cnode_{RAM}} and Node is that not filled
If best fit, worst fit or first fit:
    Sort the Nodes according to worst fit, best fit or skip this step
    in case of first fit
    For each Node i:
      If the node does not exists in evaluated_node_set
        Num_Pods_Estimatei = Cnodei/M
        Total_Pods_Estimatei = Total_Pods_Estimatei-1 +
        Num_Pods_Estimatei
        If Total_Pods_Estimatei >K
              Modify the capacity for this node i
              Mark the cluster as useable
              Break
        Else If Total_Pods_Estimatei = K
              Add the node to the evaluated_node_set
              Mark the cluster as useable
              Break
        Add the node to the evaluated_node_set
      If Total_Pods_Estimate < K
        Mark the cluster as unusable
```

In the example above, mapping the statistical metric to the plurality of nodes of each server cluster of the working set of server clusters includes calculating Num_Pods_Estimate (Cnode/M) all dimension of resources {vCPU, GPU, RAM, STORAGE_SSD, STORAGE_HDD} and using the minimum integer value. For example, M=(4 vCPU, 10 GB RAM), C=(38 vCPU, 150 GB RAM), C/M=(9.5, 15), and Cnodei/M=floor(Min(C/M))=9.

In the example above, adding the node to evaluated_node_set ensures that the same node is not repeated for multiple groups.

Mapping the statistical metric to the plurality of nodes of each server cluster of the working set of server clusters continues by repeating the node-level mappings for each server cluster of the working set of server clusters. Each usable server cluster is retained in the working set and, the working set retains the server cluster order established in operation S303.

In operation S306 of method 300, list 219 of ranked server clusters of server clusters 220, 230, . . . 240 is output by orchestrator 211 to user 250. Outputting the list of ranked server clusters includes outputting the list having the number of server clusters discussed above.

Outputting the list of ranked server clusters includes the list including the highest ordered server clusters in the working set of server clusters corresponding to the number of server clusters.

In operation S307 of method 300, application 260 is deployed by orchestrator 211 on a server cluster selected from list 219 by user 250.

In operation S308 of method 300, server cluster database 217 is updated by resource manager 215 based on deployment of application 260 on the selected server cluster of server clusters 220, 230, . . . 240.

In some embodiments, one or more of operations S310-S308 are repeated, e.g., corresponding to various operations being performed over a span of time during which data in server cluster database 217 is repeatedly updated such that results of performing operations S302-S306 are potentially affected.

By executing some or all of the operations of method 300, a device, e.g., device 210 including orchestrator 211, is capable of automatically determining qualified server clusters of a plurality of server clusters based on resource requirements of an application, selecting a working set of server clusters by calculating scores of the qualified server clusters, calculating a statistical metric of two or more subsets of the resource requirements, ranking the working set of server clusters by mapping the statistical metric to infrastructure resources of each server cluster of the working set of server clusters, and outputting a list of the ranked server clusters to a user, the list being usable for deploying the application on a selected server cluster. A system including the device, e.g., system 200 including device 210, is thereby capable of functioning to host and execute multiple software applications more efficiently than systems that function based on other approaches.

FIG. 5 is a schematic view of a system 500, in accordance with some embodiments.

In some embodiments, system 500 is an embodiment of device 210 of FIG. 2, and similar detailed description is therefore omitted.

In some embodiments, system 500 is an embodiment of one or more elements in device 210, and similar detailed description is therefore omitted. For example, in some embodiments, system 500 is an embodiment of one or more of orchestrator 211 or resource manager 215, and similar detailed description is therefore omitted.

In some embodiments, system 500 is an embodiment of one or more devices 102 in FIG. 1, and similar detailed description is therefore omitted.

In some embodiments, system 500 is an embodiment of one or more edge devices 106 in FIG. 1 or one or more servers of server clusters 220, 230, . . . 240, and similar detailed description is therefore omitted.

In some embodiments, system 500 is configured to perform one or more operations of method 300.

System 500 includes a hardware processor 502 and a non-transitory, computer readable storage medium 504 (e.g., memory 504) encoded with, i.e., storing, the computer program code 506, i.e., a set of executable instructions 506. Computer readable storage medium 504 is configured to interface with at least one of devices 102 in FIG. 1, edge devices 106 in FIG. 1, device 210, or one or more servers of server clusters 220, 230, . . . 240.

Processor 502 is electrically coupled to computer readable storage medium 504 by a bus 508. Processor 502 is also electrically coupled to an I/O interface 510 by bus 508. A network interface 512 is also electrically connected to processor 502 by bus 508. Network interface 512 is connected to a network 514, so that processor 502 and computer readable storage medium 504 are capable of connecting to external elements by network 514. Processor 502 is configured to execute computer program code 506 encoded in computer readable storage medium 504 in order to cause system 500 to be usable for performing a portion or all of the operations as described in method 300. In some embodiments, network 514 is not part of system 500. In some embodiments, network 514 is an embodiment of network 104 or 108 of FIG. 1.

In some embodiments, processor 502 is a central processing unit (CPU), a multi-processor, a distributed processing read circuit, an application specific integrated circuit (ASIC), and/or a suitable processing unit.

In some embodiments, computer readable storage medium 504 is an electronic, magnetic, optical, electromagnetic, infrared, and/or a semiconductor read circuit (or apparatus or device). For example, computer readable storage medium 504 includes a semiconductor or solid-state memory, a magnetic tape, a removable computer diskette, a random access memory (RAM), a read-only memory (ROM), a rigid magnetic disk, and/or an optical disk. In some embodiments using optical disks, computer readable storage medium 504 includes a compact disk-read only memory (CD-ROM), a compact disk-read/write (CD-R/W), and/or a digital video disc (DVD).

In some embodiments, forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

In some embodiments, storage medium 504 stores computer program code 506 configured to cause system 500 to perform one or more operations of method 300. In some embodiments, storage medium 504 also stores information used for performing method 300 as well as information generated during performing method 300, such as orchestrator 516, resource manager 518, service catalog 520, active inventory 522, user interface 524, and/or a set of executable instructions to perform one or more operations of method 300.

In some embodiments, storage medium 504 stores instructions (e.g., computer program code 506) for interfacing with at least devices 102 in FIG. 1, edge devices 106 in FIG. 1, device 210, orchestrator 211, resource manager 215, or one or more of server clusters 220, 230, . . . 240. The instructions (e.g., computer program code 506) enable processor 502 to generate instructions readable by at least devices 102 in FIG. 1, edge devices 106 in FIG. 1, device 210, orchestrator 211, resource manager 215, or one or more of server clusters 220, 230, . . . 240 to effectively implement one or more operations of method 300 during operation of device 210.

System 500 includes I/O interface 510. I/O interface 510 is coupled to external circuitry. In some embodiments, I/O interface 510 includes a keyboard, keypad, mouse, trackball, trackpad, and/or cursor direction keys for communicating information and commands to processor 502.

System 500 also includes network interface 512 coupled to the processor 502. Network interface 512 allows system 500 to communicate with network 514, to which one or more other computer read circuits are connected. Network interface 512 includes wireless network interfaces such as BLUETOOTH, WIFI, WIMAX, GPRS, or WCDMA; or wired network interface such as ETHERNET, USB, or IEEE-884. In some embodiments, method 300 is implemented in two or more systems 500, and information such as orchestrator 516, resource manager 518, service catalog 520, active inventory 522, and user interface 524 are exchanged between different systems 500 by network 514.

System 500 is configured to receive information related to orchestrator 516 through I/O interface 510 or network interface 512. The information is transferred to processor 502 by bus 508, and is then stored in computer readable medium 504 as orchestrator 516. In some embodiments, orchestrator 516 including resource manager 518 corresponds to orchestrator 211 including resource manager 215, and similar detailed description is therefore omitted. System 500 is configured to receive information related to orchestrator 516 through I/O interface 510 or network interface 512. In some embodiments, the information is stored in computer readable medium 504 as service catalog 520. In some embodiments, service catalog 520 corresponds to service catalog 213, and similar detailed description is therefore omitted. System 500 is configured to receive information related to active inventory 522 through I/O interface 510 or network interface 512. The information is stored in computer readable medium 504 as active inventory 522. In some embodiments, active inventory 522 corresponds to server cluster database 217, and similar detailed description is therefore omitted. System 500 is configured to receive information related to a user interface through I/O interface 510 or network interface 512. The information is stored in computer readable medium 504 as user interface 524.

In some embodiments, method 300 is implemented as a standalone software application for execution by a processor. In some embodiments, method 300 is implemented as corresponding software applications for execution by one or more processors. In some embodiments, method 300 is implemented as a software application that is a part of an additional software application. In some embodiments, method 300 is implemented as a plug-in to a software application.

In some embodiments, method 300 is implemented as a software application that is a portion of an orchestrator tool. In some embodiments, method 300 is implemented as a software application that is used by an orchestrator tool. In some embodiments, one or more of the operations of method 300 is not performed.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

One aspect of this description relates to a method executed by a processor. In some embodiments, the method includes receiving cumulative resource requirements of an application, wherein the application includes a plurality of pods, and the cumulative resource requirements include subsets of resource requirements corresponding to each pod of the plurality of pods, determining qualified server clusters of a plurality of server clusters based on the cumulative resource requirements, wherein each server cluster of the plurality of server clusters includes a plurality of nodes, selecting a working set of server clusters by calculating scores of the qualified server clusters, calculating a statistical metric of two or more of the subsets of resource requirements, ranking the working set of server clusters by mapping the statistical metric to infrastructure resources of the plurality of nodes of each server cluster of the working set of server clusters, and outputting a list of the ranked server clusters to a user.

Another aspect of this description relates to an apparatus. In some embodiments, the apparatus includes a memory having non-transitory instructions stored, and a processor coupled to the memory, and being configured to execute the instructions, thereby causing the apparatus to receive cumulative resource requirements of an application, wherein the application includes a plurality of pods, and the cumulative resource requirements include subsets of resource requirements corresponding to each pod of the plurality of pods, perform updates to a record of infrastructure resources of a plurality of server clusters, wherein each server cluster of the plurality of server clusters includes a plurality of nodes corresponding to sets of infrastructure resources of the infrastructure resources, determine qualified server clusters of the plurality of server clusters by comparing the cumulative resource requirements to aggregates of the sets of infrastructure resources corresponding to each server cluster of the plurality of server clusters, select a working set of server clusters by calculating scores of the qualified server clusters, calculate a statistical metric of two or more of the subsets of resource requirements, rank the working set of server clusters by mapping the statistical metric to the sets of infrastructure resources corresponding to each server cluster of the working set of server clusters, and output a list of the ranked server clusters to the user interface.

Still another aspect of this description relates to a computer-readable medium. In some embodiments, the computer-readable medium includes instructions executable by a controller of a user equipment to cause the controller to perform operations including receiving cumulative resource requirements of an application, wherein the application includes a plurality of pods, and the cumulative resource requirements include subsets of resource requirements corresponding to each pod of the plurality of pods, performing updates to a record of infrastructure resources of a plurality of server clusters, wherein each server cluster of the plurality of server clusters includes a plurality of nodes corresponding to sets of infrastructure resources of the infrastructure resources, determining qualified server clusters of the plurality of server clusters by comparing the cumulative resource requirements to aggregates of the sets of infrastructure resources corresponding to each server cluster of the plurality of server clusters, selecting a working set of server clusters by calculating scores of the qualified server clusters, receiving a window number from an input of the user equipment, calculating one of a minimum, a maximum, a mean, or a median of a portion of the subsets of resource requirements corresponding to the window number, ranking the working set of server clusters by mapping the statistical metric to the sets of infrastructure resources corresponding to each server cluster of the working set of server clusters, and generating a list of the ranked server clusters.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method executed by a processor, the method comprising:
receiving cumulative resource requirements of an application, wherein
the application comprises a plurality of pods, and
the cumulative resource requirements comprise subsets of resource requirements corresponding to each pod of the plurality of pods;
determining qualified server clusters of a plurality of server clusters based on the cumulative resource requirements, wherein each server cluster of the plurality of server clusters comprises a plurality of nodes;
selecting a working set of server clusters by calculating scores of the qualified server clusters;
calculating a statistical metric of two or more of the subsets of resource requirements;
ranking the working set of server clusters by mapping the statistical metric to infrastructure resources of the plurality of nodes of each server cluster of the working set of server clusters; and
outputting a list of the ranked server clusters to a user.

2. The method of claim 1, wherein each subset of resource requirements comprises one or more of a central processing unit (CPU) requirement, a graphics processing unit (GPU) requirement, a memory requirement, a hard disk drive (HDD) storage requirement, a solid state drive (SSD) storage requirement, or a field-programmable gate array (FPGA) requirement.

3. The method of claim 1, wherein
each node of the plurality of nodes of each server cluster of the plurality of server clusters comprises a set of infrastructure resources of the infrastructure resources, and
determining the qualified server clusters comprises comparing an aggregate of the sets of infrastructure resources of each server cluster of the plurality of server clusters to the cumulative resource requirements.

4. The method of claim 3, further comprising:
updating at least one set of infrastructure resources of a node of the plurality of nodes of a server cluster of the plurality of server clusters,
wherein determining the qualified server clusters comprises comparing the aggregate of the sets of infrastructure resources based on the updated at least one set of infrastructure resources.

5. The method of claim 1, wherein calculating the scores of the qualified server clusters comprises summing differences between server cluster capacity and the cumulative resource requirements for each requirement of a plurality of requirements of the cumulative resource requirements.

6. The method of claim 1, wherein calculating the statistical metric of the two or more of the subsets of resource requirements comprises:
calculating a normalized score for each pod of the plurality of pods; and
sorting the plurality of pods based on the normalized scores.

7. The method of claim 1, wherein calculating the statistical metric comprises calculating one of a minimum, a maximum, a mean, or a median.

8. The method of claim 1, wherein calculating the statistical metric comprises receiving an indication of a number of pods of the plurality of pods corresponding to the two or more of the subsets of resource requirements included in the statistical metric calculation.

9. The method of claim 1, further comprising:
receiving, from the user, an instruction comprising a selection of a server cluster in the list of server clusters; and
in response to the instruction, deploying the application on the selected server cluster.

10. An apparatus, comprising:
a user interface;
a memory having non-transitory instructions stored; and
a processor coupled to the memory, and being configured to execute the instructions, thereby causing the apparatus to:
receive cumulative resource requirements of an application, wherein
the application comprises a plurality of pods, and
the cumulative resource requirements comprise subsets of resource requirements corresponding to each pod of the plurality of pods;
perform updates to a record of infrastructure resources of a plurality of server clusters, wherein each server cluster of the plurality of server clusters comprises a plurality of nodes corresponding to sets of infrastructure resources of the infrastructure resources;
determine qualified server clusters of the plurality of server clusters by comparing the cumulative resource requirements to aggregates of the sets of infrastructure resources corresponding to each server cluster of the plurality of server clusters;
select a working set of server clusters by calculating scores of the qualified server clusters;
calculate a statistical metric of two or more of the subsets of resource requirements;
rank the working set of server clusters by mapping the statistical metric to the sets of infrastructure resources corresponding to each server cluster of the working set of server clusters; and
output a list of the ranked server clusters to the user interface.

11. The apparatus of claim 10, wherein each subset of resource requirements comprises one or more of a central processing unit (CPU) requirement, a graphics processing unit (GPU) requirement, a memory requirement, a hard disk drive (HDD) storage requirement, a solid state drive (SSD) storage requirement, or a field-programmable gate array (FPGA) requirement.

12. The apparatus of claim 10, wherein the instructions cause the apparatus to calculate the scores of the qualified server clusters by summing differences between the corresponding aggregates of the sets of infrastructure resources and the cumulative resource requirements for each requirement of a plurality of requirements of the cumulative resource requirements.

13. The apparatus of claim 10, wherein the instructions cause the apparatus to calculate the statistical metric of the two or more of the subsets of resource requirements by:
calculating a normalized score for each pod of the plurality of pods; and
sorting the plurality of pods based on the normalized scores.

14. The apparatus of claim 10, wherein the instructions further cause the apparatus to:
receive an instruction from the user interface; and
based on the instruction, calculate the statistical metric by calculating one of a minimum, a maximum, a mean, or a median.

15. The apparatus of claim 10, wherein the instructions further cause the apparatus to receive, from the user interface, an indication of a number of pods of the plurality of pods corresponding to the two or more of the subsets of resource requirements included in the statistical metric calculation.

16. The apparatus of claim 10, wherein the instructions further cause the apparatus to:
receive, from the user interface, an instruction comprising a selection of a server cluster in the list of server clusters; and
in response to the instruction, deploy the application on the selected server cluster.

17. A computer-readable medium including instructions executable by a controller of a user equipment to cause the controller to perform operations comprising:
receiving cumulative resource requirements of an application, wherein
the application comprises a plurality of pods, and
the cumulative resource requirements comprise subsets of resource requirements corresponding to each pod of the plurality of pods;
performing updates to a record of infrastructure resources of a plurality of server clusters, wherein each server cluster of the plurality of server clusters comprises a plurality of nodes corresponding to sets of infrastructure resources of the infrastructure resources;
determining qualified server clusters of the plurality of server clusters by comparing the cumulative resource requirements to aggregates of the sets of infrastructure resources corresponding to each server cluster of the plurality of server clusters;
selecting a working set of server clusters by calculating scores of the qualified server clusters;
receiving a window number from an input of the user equipment;
calculating one of a minimum, a maximum, a mean, or a median of a portion of the subsets of resource requirements corresponding to the window number;
ranking the working set of server clusters by mapping the statistical metric to the sets of infrastructure resources corresponding to each server cluster of the working set of server clusters; and
generating a list of the ranked server clusters.

18. The computer-readable medium of claim 17, wherein each subset of resource requirements comprises one or more of a central processing unit (CPU) requirement, a graphics processing unit (GPU) requirement, a memory requirement, a hard disk drive (HDD) storage requirement, a solid state drive (SSD) storage requirement, or a field-programmable gate array (FPGA) requirement.

19. The computer-readable medium of claim 17, wherein calculating the scores of the qualified server clusters comprises summing differences between the corresponding aggregates of the sets of infrastructure resources and the cumulative resource requirements for each requirement of a plurality of requirements of the cumulative resource requirements.

20. The computer-readable medium of claim 17, wherein calculating the statistical metric of the two or more of the subsets of resource requirements comprises:
calculating a normalized score for each pod of the plurality of pods; and
sorting the plurality of pods based on the normalized scores.
